(19) United States
(12) Patent Application Publication
(10) Pub. No.: US 2025/0309590 A1
(43) Pub. Date: Oct. 2, 2025

(54) CONNECTOR ASSEMBLY WITH ARCING REDUCEMENT CONFIGURATION

(71) Applicant: Lanto Electronic Limited, Kunshan City (CN)

(72) Inventors: Yueh-Ting Hsieh, Kunshan City (CN); Fu-Tsun SUN, Kunshan City (CN); Tsung-Min CHEN, Kunshan City (CN); Chia-Wei CHOU, Kunshan City (CN)

(73) Assignee: Lanto Electronic Limited, Kunshan City (CN)

(21) Appl. No.: 18/825,446

(22) Filed: Sep. 5, 2024

(30) Foreign Application Priority Data
Apr. 2, 2024 (CN) 202410392378.4

(51) Int. Cl. H01R 13/66; H01R 13/703

(52) U.S. Cl. CPC H01R 13/6683; H01R 13/7036

(57) ABSTRACT

A connector assembly includes a first connector and a second connector. The first connector includes a detection circuit and a detection element. The detection circuit is electrically connected to the detection element. The second connector is capable of mating with the first connector. The detection element is used to detect whether a plugging action or an unplugging action is performed between the first connector and the second connector. If the detection element detects that the plugging action is performed, the first connector is powered-on through the detection circuit later than a plugging moment. If the detection element detects that the unplugging action is performed, the first connector is powered-off through the detection circuit earlier than an unplugging moment. The connector assembly of the present disclosure can reduce arcing.

### CROSS-REFERENCE TO RELATED APPLICATION

This patent application claims priority of a Chinese Patent Application No. 202410392378.4, filed on Apr. 2, 2024 and titled “CONNECTOR ASSEMBLY”, the entire content of which is incorporated herein by reference.

### TECHNICAL FIELD

The present disclosure relates to a field of connector, and in particular to a connector assembly capable of reducing arcing.

### BACKGROUND

The connector assembly usually includes a first connector and a second connector. The first connector, which is a socket (or “female”) connector, can be plug-fitted with the second connector, which is a plug (or “male”) connector to achieve an electrical connection to transmit signals. Once the first connector is unplugged from the second connector, the contacts of the first connector are physically and electrically disconnected from the contacts of the second connector. Under the sudden change of the insertion/extraction current, the metal surfaces of the contacts cause electrons to escape due to primary electron emission (thermal ion emission, field emission or photoelectric emission), and the gas atoms or molecules in the gap will be ionized (impact ionization, photoionization and thermal ionization) to produce electrons and ions. When the ion concentration in the gap is large enough, the air will be electrically broken down and an arc will occur. That is to say, arc is a high-temperature and highly conductive free gas. It not only has a great destructive effect on the contacts, but also can break and extend the circuit between the contacts of the plug connector and the contacts of the receptacle connector. Therefore, how to avoid or reduce arc effects and reduce costs is a long-term consideration and urgent problem for those skilled in the art.

### SUMMARY

An object of the present disclosure is to provide a connector assembly which is capable of reducing arcing.

In order to achieve the above object, the present disclosure adopts the following technical solution: a connector assembly includes a first connector and a second connector. The first connector includes a detection circuit and a detection element. The detection circuit is electrically connected to the detection element. The second connector is capable of mating with the first connector. The detection element is used to detect whether a plugging action or an unplugging action is performed between the first connector and the second connector. If the detection element detects that the plugging action is performed, the first connector is powered-on through the detection circuit later than a plugging moment. If the detection element detects that the unplugging action is performed, the first connector is powered-off through the detection circuit earlier than an unplugging moment.

In order to achieve the above object, the present disclosure adopts the following technical solution: a connector assembly includes a first connector, a second connector and a detection element. The receptacle connector is plug-fitted with the plug connector. The detection element detects whether a plugging action or an unplugging action is performed between the plug connector and the receptacle connector. The receptacle connector includes the detection element.

In order to achieve the above object, the present disclosure adopts the following technical solution: a connector assembly includes a first connector, a second connector and a detection element. The receptacle connector is plug-fitted with the plug connector. The detection element is used to detect whether the plug connector performs a plugging action or an unplugging action to the receptacle connector. The plug connector begins to be powered-on at a few seconds later than that the plug connector performs the plugging action to the receptacle connector. The plug connector begins to be powered-off at another few seconds earlier than that the plug connector performs the unplugging action to the receptacle connector.

Compared with the prior art, the connector assembly of the present disclosure reduces the generation of arcs and therefore, the first connector and the second connector have a protective effect during the mutual insertion/retraction operation. Furthermore, the connector assembly of the present disclosure reduces the replacement cost when it is damaged.

### BRIEF DESCRIPTION OF DRAWINGS

FIG. 1 is a perspective, assembled view of a connector assembly in accordance with a first embodiment of the present disclosure;

FIG. 2 is a perspective, assembled view of a connector assembly in accordance with a first specific implementation mode of a second embodiment of the present disclosure;

FIG. 3 is a perspective, assembled view of a connector assembly in accordance with a second specific implementation mode of the second embodiment of the present disclosure;

FIG. 4 is a first circuit schematic diagram corresponding to FIG. 1;

FIG. 5 is a second circuit schematic diagram corresponding to FIG. 2; and

FIG. 6 is a third circuit schematic diagram corresponding to FIG. 3.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different elements. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

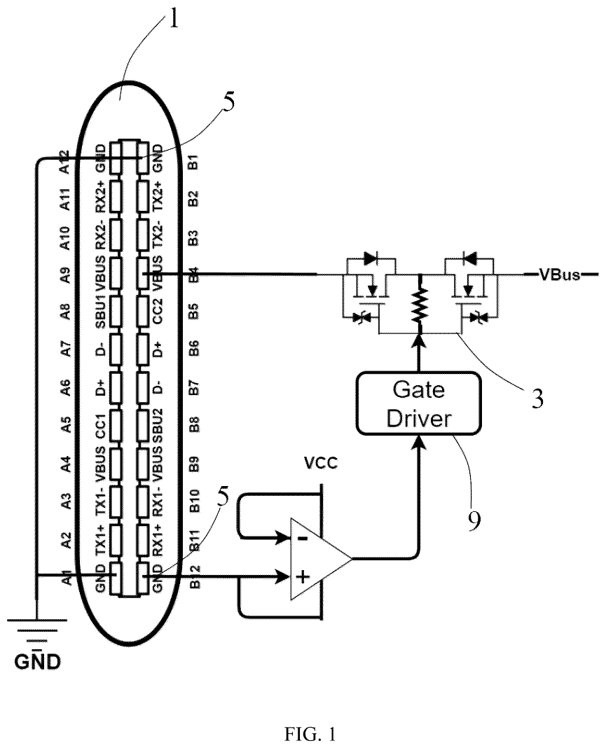

Referring to FIG. 1 to FIG. 3, the present disclosure relates to a connector assembly. The connector assembly includes a first connector and a second connector, which two are capable of being mated with each other. The first connector includes a detection circuit 3 and a detection element (detailed described later). The detection circuit 3 is electrically connected to the detection element. The detection element is used to detect whether a plugging action or an unplugging action is performed between the first connector and the second connector. If the detection element detects that the plugging action is performed, the first connector is powered-on through the detection circuit 3 later than a plugging moment. If the detection element detects that the unplugging action is performed, the first connector is powered-off through the detection circuit 3 earlier than an unplugging moment. The connector assembly of the present disclosure can reduce arcing.

The connector assembly of the present disclosure achieves the effects of delayed powered-on and rapid powered-off by configuring the detection circuit 3 and the detection element. That is, it delays to supply power when plugging and quickly cuts off power when unplugging, thereby reducing arcs. It realizes the protection function during the mutual insertion/plugging process of the first connector and the second connector and extraction/unplugging process of the first connector and the second connector. Specifically, the first connector is a receptacle connector 1 and the second connector is a plug connector 2. The detection element is located in or on the receptacle connector 1. Optionally, the detection circuit 3 is one of an electronic detection circuit and a magnetic detection circuit. That is, the detection circuit 3 includes the following two embodiments.

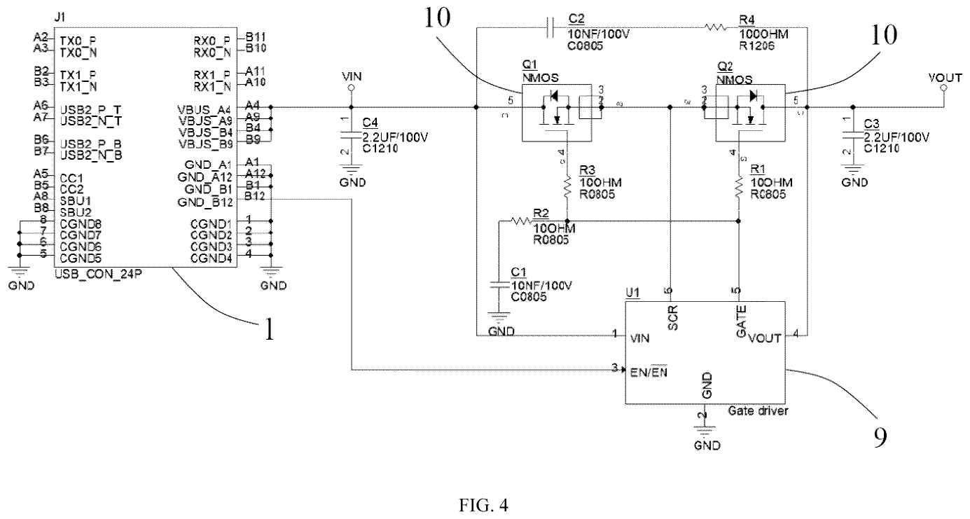

Referring to FIG. 1 and FIG. 4, in a first embodiment of the present disclosure, the detection circuit 3 is an electronic detection circuit, the detection element includes a grounding pin 5 of the receptacle connector 1. Accordingly, the plug connector 2 comprises a corresponding mating pin corresponding to the grounding pin 5 of the receptacle connector 1. Referring to FIG. 1, when the plug connector 2 and the receptacle connector 1 perform the plugging action in such that the grounding pin 5 of the receptacle connector 1 is in touch with the corresponding mating pin of the plug connector 2, a first detection signal is generated between the grounding pin and the corresponding mating pin. The detection circuit detects the first detection signal as a low potential, causing a positive power path between the plug connector 2 and the receptacle connector 1 to be a connected state. When the plug connector 2 and the receptacle connector 1 perform the unplugging action in such that the grounding pin of the receptacle connector 1 is not in touch with the corresponding mating pin of the plug connector 2, the detection circuit detects the first detection signal as a high potential, causing the positive power path between the plug connector 2 and the receptacle connector 1 to be a disconnected state. The essence of the first embodiment is to utilize the characteristics that the grounding pin 5 and the shielding shell (not numbered) of the receptacle connector 1 are all connected together to complete the connection or disconnection of the positive power path.

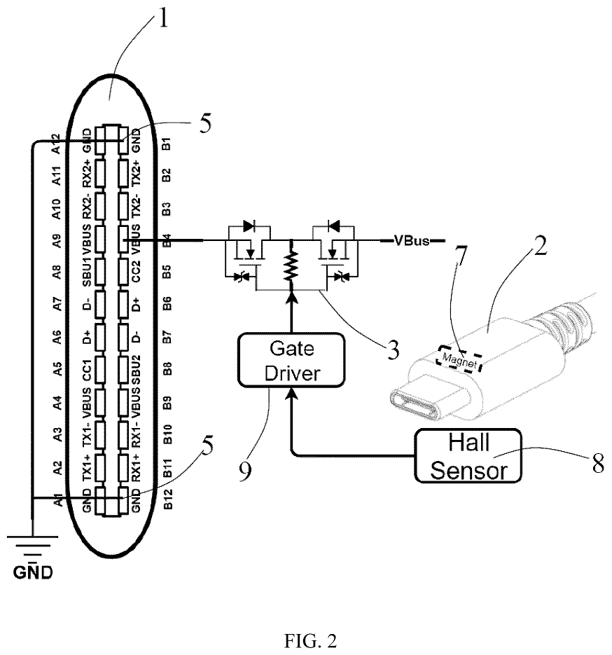

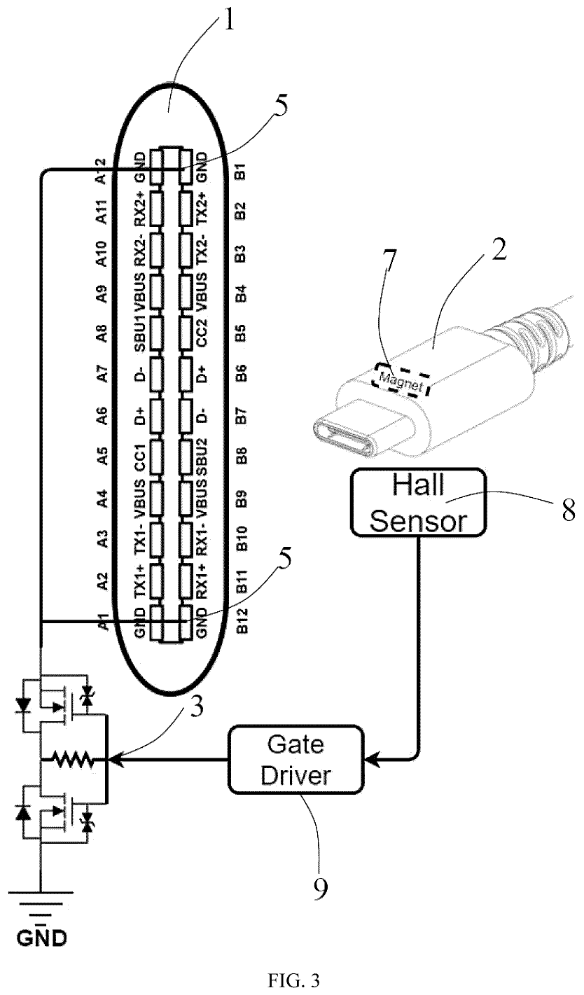

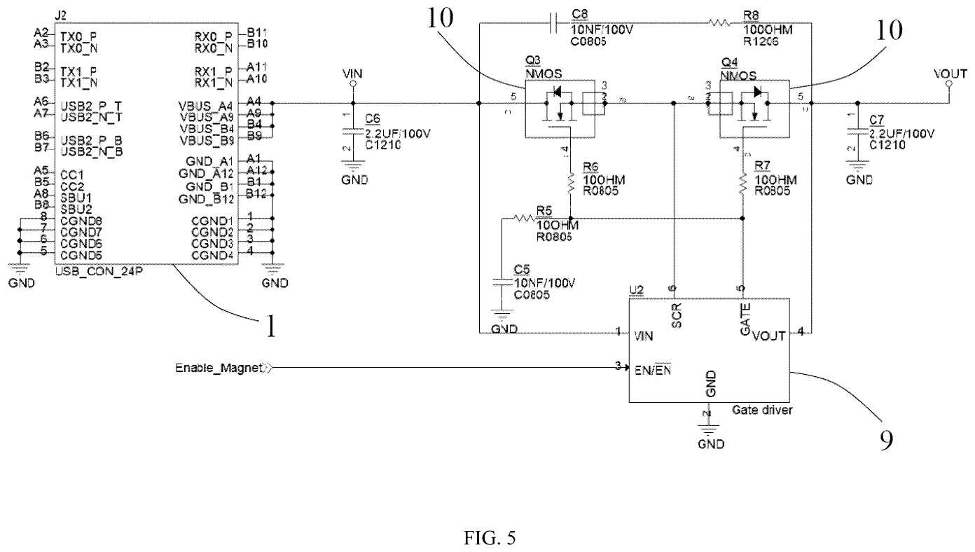

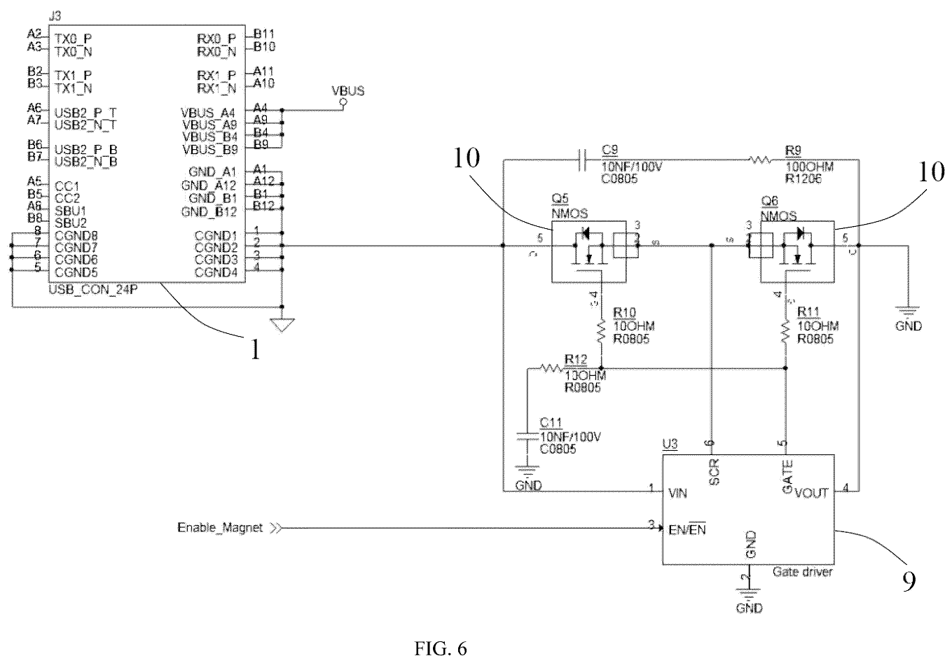

Referring to FIG. 2, FIG. 3, FIG. 5 and FIG. 6, in a second embodiment of the present disclosure (including two specific implementation modes), the detection circuit 3 is a magnetic detection circuit, the detection element includes a Hall sensor 8 on the receptacle connector 1, and the plug connector 2 comprises a sensing element 7. When the plug connector 2 and the receptacle connector 1 perform the plugging action in such that the sensing element 7 triggers the Hall sensor 8 to generate a second detection signal, the detection circuit detects the second detection signal as a low-potential detection signal, causing either a positive power path or a negative power path between the plug connector 2 and the receptacle connector 1 to be a connected state. Referring to FIG. 2, the first specific implementation mode of the second embodiment is: the low-potential detection signal causes the detection circuit 3 of the positive power path to be in a connected state. Referring to FIG. 3, the second specific implementation mode of the second embodiment is: the low-potential detection signal causes the detection circuit 3 of the negative power path to be in a connected state. When the plug connector 2 and the receptacle connector 1 perform the unplugging action, the detection circuit detects the second detection signal generated between the sensing element 7 and the Hall sensor 8 as a high-potential detection signal, causing either the positive power path or the negative power path between the plug connector 2 and the receptacle connector 1 to be a disconnected state. Referring to FIG. 2 again, the first specific implementation mode of the second embodiment is: the high-potential detection signal causes the detection circuit 3 of the positive power path to be in a disconnected state. Referring to FIG. 3 again, the second specific implementation mode of the second embodiment is: the high-potential detection signal causes the detection circuit 3 of the negative power path to be in a disconnected state. Generally speaking, in the two specific implementation modes of the second embodiment of the present disclosure, through the detection signal (high-potential or low-potential) generated between the sensing element 7 and the Hall sensor 8, the detection circuit 3 turns on or turns off the positive/negative power path.

It should be emphasized that: in the second embodiment of the present disclosure, the detection signal output by the Hall sensor 8 can be either a high-potential detection signal or a low-potential detection signal. It should be also emphasized that: there are two ways to connect the magnetic detection circuit. The first one is to connect VBUS to positive power, and the other one is to connect to GND to negative power. Therefore, disconnection of the magnetic detection circuit can be a positive power path or a negative power path accordingly. It should be further emphasized that: the sensing element 7 is disposed as a component of the plug connector 2, and the Hall sensor 8 is located on the receptacle connector 1 corresponding to the position of the sensing element 7. For example: if the sensing element 7 is disposed on a top surface of the plug connector 2, then the Hall sensor 8 is also disposed on a top surface of the receptacle connector 1; if the sensing element 7 is disposed at a lateral side of the plug connector 2, then the Hall sensor 8 is also disposed at a corresponding side of the receptacle connector 1; and so on. Specifically, the sensing element 7 is a magnet or other magnetic objects.

The abovementioned is the entire content of a first technical solution of the present disclosure. In other words, the present disclosure also discloses a second technical solution of a connector assembly including a plug connector 2 and a receptacle connector 1. The connector assembly disclosed in the second technical solution further includes a detection element for detecting whether the plug connector 2 and the receptacle connector 1 are plugged/unplugged. Furthermore, the receptacle connector 1 includes the detection element. The disclosed connector assembly avoids the problems of the prior art, by arranging the detection element on the receptacle connector 1 with a stable position, for detecting whether the plug connector 2 and the receptacle connector 1 are plugged/unplugged. This eliminates the disadvantages caused by arranging the detection element on the moving plug connector 2 and reduces the replacement cost when it is damaged. Referring to FIG. 4 to FIG. 6, it can be further understood that in the second technical solution, the disclosed connector assembly further includes a detection circuit 3. The detection circuit 3 is electrically connected to the detection element and the detection circuit 3 is one of electronic detection circuit and magnetic detection circuit. That is, the detection circuit 3 includes the following two embodiments.

In the first embodiment of the second technical solution of the present disclosure, the detection circuit 3 is an electronic detection circuit, the detection element includes a grounding pin 5 of the receptacle connector 1. Accordingly, the plug connector 2 comprises a corresponding mating pin corresponding to the grounding pin 5 of the receptacle connector 1. Referring to FIG. 1, when the plug connector 2 and the receptacle connector 1 perform the plugging action in such that the grounding pin 5 of the receptacle connector 1 is in touch with the corresponding mating pin of the plug connector 2, a first detection signal is generated between the grounding pin and the corresponding mating pin. The detection circuit detects the first detection signal as a low potential, causing a positive power path between the plug connector 2 and the receptacle connector 1 to be a connected state. When the plug connector 2 and the receptacle connector 1 perform the unplugging action in such that the grounding pin of the receptacle connector 1 is not in touch with the corresponding mating pin of the plug connector 2, the detection circuit detects the first detection signal as a high potential, causing the positive power path between the plug connector 2 and the receptacle connector 1 to be a disconnected state. The essence of the first embodiment is to utilize the characteristics that the grounding pin 5 and the shielding shell (not numbered) of the receptacle connector 1 are all connected together to complete the connection or disconnection of the positive power path.

In the second embodiment of the second technical solution of the present disclosure (including two specific implementation modes), the detection circuit 3 is a magnetic detection circuit, the detection element includes a Hall sensor 8 on the receptacle connector 1, and the plug connector 2 comprises a sensing element 7. When the receptacle connector 1 and the plug connector 2 perform the plugging action in such that the sensing element 7 triggers the Hall sensor 8 to generate a second detection signal, the detection circuit detects the second detection signal as a low-potential detection signal, causing either a positive power path or a negative power path between the plug connector 2 and the receptacle connector 1 to be a connected state. Referring to FIG. 2 and FIG. 5, the first specific implementation mode of the second embodiment is: the low-potential detection signal causes the detection circuit 3 of the positive power path to be in a connected state. Referring to FIG. 3 and FIG. 6, the second specific implementation mode of the second embodiment is: the low-potential detection signal causes the detection circuit 3 of the negative power path to be in a connected state. When the plug connector 2 and the receptacle connector 1 perform the unplugging action, the detection circuit detects the second detection signal generated between the sensing element 7 and the Hall sensor 8 as a high-potential detection signal, causing either the positive power path or the negative power path between the plug connector 2 and the receptacle connector 1 to be a disconnected state. Referring to FIG. 2 again, the first specific implementation mode of the second embodiment is: the high-potential detection signal causes the detection circuit 3 of the positive power path to be in a disconnected state. Referring to FIG. 3 again, the second specific implementation mode of the second embodiment is: the high-potential detection signal causes the detection circuit 3 of the negative power path to be in a disconnected state. Generally speaking, in the two specific implementation modes of the second embodiment of the present disclosure, through the detection signal (high-potential or low-potential) generated between the sensing element 7 and the Hall sensor 8, the detection circuit 3 turns on or turns off the positive/negative power path.

The following explanation is made with reference to the receptacle connector 1 in FIG. 1 and the circuit schematic diagram in FIG. 4. According to the pin definition of the USB Association Type-C connector, the grounding pins 5 of the receptacle connector 1 are respectively labeled as Pin. A1, Pin. B1, Pin. A12, Pin. B12. Leave one of the grounding pins 5 (for example, Pin. B12 in the schematic diagram) open and ungrounded to form a non-low potential state. When the plug connector 2 is inserted, using the characteristic that all grounding pins 5 of the receptacle connector 1 are connected together, Pin. B12 forms a low potential after plug connector 2 is inserted and the gate driver 9 activates the detection circuit 3, further coupled with the slow start circuit of the gate driver 9, which enables the two semiconductor elements 10 (for example, NMOS in the schematic diagram) to slowly conduct the positive power circuit. On the contrary, unplugging of the plug connector 2 causes the gate driver 9 to stop operating the detection circuit 3. The gate driver 9 quickly cuts off power, causing the two semiconductor elements 10 to be open circuit to achieve the purpose of rapid power outage of the positive power circuit.

The following explanation is made with reference to the receptacle connector 1 in FIG. 2 and the circuit schematic diagram of FIG. 5. When the plug connector 2 is inserted, the Hall sensor 8 of the receptacle connector 1 is used to sense the sensing element 7 of the plug connector 2. The Hall sensor 8 outputs high or low potential and the gate driver 9 operates the detection circuit 3, further coupled with the slow start circuit of the gate driver 9, which enables the two semiconductor elements 10 to slowly conduct the positive power circuit. On the contrary, unplugging of the plug connector 2 causes the gate driver 9 to stop operating the detection circuit 3. The gate driver 9 quickly cuts off power, causing the two semiconductor elements 10 to be open circuit to achieve the purpose of rapid power outage of the positive power circuit.

The following explanation is made with reference to the receptacle connector 1 in FIG. 3 and the circuit schematic diagram of FIG. 6. When the plug connector 2 is inserted, the Hall sensor 8 on the receptacle connector 1 is used to sense the sensing element 7 on the plug connector 2. The Hall sensor 8 outputs high or low potential and the gate driver 9 operates the detection circuit 3, further coupled with the slow start circuit of the gate driver 9, which enables the two semiconductor elements 10 to slowly conduct the negative power circuit. On the contrary, unplugging of the plug connector 2 causes the gate driver 9 to stop operating the detection circuit 3. The gate driver 9 quickly cuts off power, causing the two semiconductor elements 10 to be open circuit to achieve the purpose of quickly cutting off the negative power circuit.

The present disclosure further discloses a third technical solution of a connector assembly including a plug connector 2, a receptacle connector 1 and a detection element. The receptacle connector 1 is plug-fitted with the plug connector 2. The detection element is used to detect whether the plug connector 2 performs a plugging action or an unplugging action to the receptacle connector 1. The plug connector 2 begins to be powered-on at a few seconds later than that the plug connector 2 performs the plugging action to the receptacle connector 1. The plug connector 2 begins to be powered-off at another few seconds earlier than that the plug connector 2 performs the unplugging action to the receptacle connector 1. The connector assembly of the third technical solution of the present disclosure achieves the effects of delayed powered-on and rapid powered-off by configuring the detection element, and therefore, the connector assembly can reduce arcing.

This connector assembly of the present disclosure, has at least two advantages:

On the one hand, the connector assembly of the present disclosure provides a detection circuit 3 and a detection element, the detection circuit 3 is electrically connected to the detection element, and the detection element is used to detect whether a plugging action or an unplugging action is performed between the first connector and the second connector. If the detection element detects that the plugging action is performed, the first connector is powered-on through the detection circuit later than a plugging moment. If the detection element detects that the unplugging action is performed, the first connector is powered-off through the detection circuit earlier than an unplugging moment. The present disclosure has the effect of delayed powered-on and rapid powered-off of the power supply path during the plugging/unplugging operation, reducing the generation of arcs thereby. Therefore, first connector and the second connector have a protective effect during the mutual insertion/retraction operation.

On the other hand, the remained problem in the prior art has a disadvantage caused by arranging the detection element on the movable plug connector 2. By arranging the detection element on the receptacle connector 1 in a stable position, the present disclosure avoids the remained problem in the prior art and reduces the replacement cost when it is damaged.

Overall, the design purpose of the three technical solutions disclosed in the present disclosure is to cut off the instantaneous power supply loop during plugging/unplugging and reduce the power consumption load on the loop, so as to avoid the instantaneous changes in voltage difference or current at both ends during plugging/unplugging, and so as to avoid generated sparks that may damage the two mating connectors.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A connector assembly, comprising:
a first connector comprising a detection circuit and a detection element, the detection circuit being electrically connected to the detection element; and
a second connector being capable of mating with the first connector;
wherein the detection element is configured to detect whether a plugging action or an unplugging action is performed between the first connector and the second connector;
if the detection element detects that the plugging action is performed, the first connector is powered-on through the detection circuit later than a plugging moment; and
if the detection element detects that the unplugging action is performed, the first connector is powered-off through the detection circuit earlier than an unplugging moment.

2. The connector assembly according to claim 1, wherein the first connector is a receptacle connector and the second connector is a plug connector.

3. The connector assembly according to claim 2, wherein the detection element is retained in the receptacle connector.

4. The connector assembly according to claim 3, wherein the detection circuit is one of an electronic detection circuit and a magnetic detection circuit.

5. The connector assembly according to claim 4, wherein the detection element comprises a grounding pin in the receptacle connector and the plug connector comprises a corresponding mating pin;
when the plug connector and the receptacle connector perform the plugging action in such that the grounding pin is in touch with the corresponding mating pin and a first detection signal is generated therebetween, the detection circuit detects the first detection signal as a low potential, causing a positive power path between the plug connector and the receptacle connector to be a connected state;
when the plug connector and the receptacle connector perform the unplugging action in such that the grounding pin is not in touch with the corresponding mating pin, the detection circuit detects the first detection signal as a high potential, causing the positive power path between the plug connector and the receptacle connector to be a disconnected state.

6. The connector assembly according to claim 4, wherein the detection element comprises a Hall sensor on the receptacle connector and the plug connector comprises a sensing element;
when the plug connector and the receptacle connector perform the plugging action in such that the sensing element triggers the Hall sensor to generate a second detection signal, the detection circuit detects the second detection signal, causing either a positive power path or a negative power path between the plug connector and the receptacle connector to be a connected state;
when the plug connector and the receptacle connector perform the unplugging action, the detection circuit detects the second detection signal generated between the sensing element and the Hall sensor, causing either the positive power path or the negative power path between the plug connector and the receptacle connector to be a disconnected state.

7. A connector assembly, comprising:
a plug connector;
a receptacle connector being plug-fitted with the plug connector; and
a detection element detecting whether a plugging action or an unplugging action is performed between the plug connector and the receptacle connector;
wherein the receptacle connector comprises the detection element.

8. The connector assembly according to claim 7, further comprising a detection circuit electrically connected to the detection element, wherein the detection circuit is one of an electronic detection circuit and a magnetic detection circuit.

9. The connector assembly according to claim 8, wherein the detection element comprises a grounding pin in the receptacle connector and the plug connector comprises a corresponding mating pin;
when the plug connector and the receptacle connector perform the plugging action in such that the grounding pin is in touch with the corresponding mating pin and a first detection signal is generated therebetween, the detection circuit detects the first detection signal as a low potential, causing a positive power path between the plug connector and the receptacle connector to be a connected state;
when the plug connector and the receptacle connector perform the unplugging action in such that the grounding pin is not in touch with the corresponding mating pin, the detection circuit detects the first detection signal as a high potential, causing the positive power path between the plug connector and the receptacle connector to be a disconnected state.

10. The connector assembly according to claim 8, wherein the detection element comprises a Hall sensor on the receptacle connector and the plug connector comprises a sensing element;
when the plug connector and the receptacle connector perform the plugging action in such that the sensing element triggers the Hall sensor to generate a second detection signal, the detection circuit detects the second detection signal, causing either a positive power path or a negative power path between the plug connector and the receptacle connector to be a connected state;
when the plug connector and the receptacle connector perform the unplugging action, the detection circuit detects the second detection signal generated between the sensing element and the Hall sensor, causing either the positive power path or the negative power path between the plug connector and the receptacle connector to be a disconnected state.

11. A connector assembly, comprising:
a plug connector;
a receptacle connector being plug-fitted with the plug connector; and
a detection element which is used to detect whether the plug connector performs a plugging action or an unplugging action to the receptacle connector; wherein
the plug connector begins to be powered-on at a few seconds later than that the plug connector performs the plugging action to the receptacle connector; and
the plug connector begins to be powered-off at another few seconds earlier than that the plug connector performs the unplugging action to the receptacle connector.

12. The connector assembly according to claim 11, further comprising a detection circuit, wherein the detection circuit is electrically connected to the detection element.

13. The connector assembly according to claim 12, wherein the detection circuit is one of an electronic detection circuit and a magnetic detection circuit.

14. The connector assembly according to claim 13, wherein the detection element comprises a grounding pin in the receptacle connector and the plug connector comprises a corresponding mating pin;
when the plug connector and the receptacle connector perform the plugging action in such that the grounding pin is in touch with the corresponding mating pin and a first detection signal is generated therebetween, the detection circuit detects the first detection signal as a low potential, causing a positive power path between the plug connector and the receptacle connector to be a connected state;
when the plug connector and the receptacle connector perform the unplugging action in such that the grounding pin is not in touch with the corresponding mating pin, the detection circuit detects the first detection signal as a high potential, causing the positive power path between the plug connector and the receptacle connector to be a disconnected state.

15. The connector assembly according to claim 13, wherein the detection element comprises a Hall sensor on the receptacle connector and the plug connector comprises a sensing element;
when the plug connector and the receptacle connector perform the plugging action in such that the sensing element triggers the Hall sensor to generate a second detection signal, the detection circuit detects the second detection signal, causing either a positive power path or a negative power path between the plug connector and the receptacle connector to be a connected state;
when the plug connector and the receptacle connector perform the unplugging action, the detection circuit detects the second detection signal generated between the sensing element and the Hall sensor, causing either the positive power path or the negative power path between the plug connector and the receptacle connector to be a disconnected state.
